(19) United States
(12) Patent Application Publication
(10) Pub. No.: US 2026/0308857 A1
(43) Pub. Date: Oct. 8, 2026

(54) MONITORING AND CONTROL OF TRAFFIC CONTROL DEVICES IN WORK ZONES

(71) Applicant: SITE 2020 INCORPORATED, Dartmouth (CA)

(72) Inventors: Mitchell Alexander HOLLOHAN, Dartmouth (CA); Craig SHEPPARD, Dartmouth (CA)

(21) Appl. No.: 19/642,289

(22) Filed: Apr. 8, 2026

Related U.S. Application Data
(60) Provisional application No. 63/785,161, filed on Apr. 8, 2025.

(51) Int. Cl. E01F 9/30; E01F 9/608; G08G 1/0955

(52) U.S. Cl. CPC E01F 9/30; E01F 9/608; G08G 1/0955

(57) ABSTRACT

A sensing device for use with a traffic control device is described. The sensing device includes a positioning sensor configured to determine a geographic position, a motion sensor configured to detect movement or tilt, a communication module, and a controller. The controller configured to activate the sensing device in response to deployment of the traffic control device; acquire telemetry representing physical conditions of the traffic control device; transmit the telemetry to a central control system; and modify an operational mode of the sensing device in response to a control instruction received from the central control system. A system for monitoring and controlling the traffic control devices deployed in a work zone is also described. A method for controlling the sensing and a method for monitoring and controlling traffic control devices deployed in a work zone are also described.

### FIELD

The present specification relates generally to control of traffic control devices and specifically to a system and method for monitoring and control of traffic control devices deployed in a work zone.

### BACKGROUND

Temporary traffic control (TTC) work zones require deployment of traffic control devices, including signs, barriers, and signaling equipment, for example, in prescribed spatial arrangements to ensure safe and efficient traffic flow. These arrangements are typically defined by standardized traffic control plans that specify device types, positions, spacing, and orientation relative to roadway conditions. In practice, however, the deployment of the traffic control devices is subject to environmental disturbances, human error, and changing site conditions, which can cause devices to deviate from their intended configuration over time without detection.

Existing approaches to verifying proper deployment of traffic control devices rely primarily on manual inspection techniques, such as visual inspections and physical measurement of distances between devices. These approaches are labour intensive and provide only intermittent, point-in-time assessments. Between inspections, signs may be displaced by wind, struck by vehicles, or otherwise become non-compliant without detection.

It is an object of the present disclosure to obviate or mitigate at least some of the above-mentioned disadvantages.

### SUMMARY

The present disclosure describes a system and method for continuously monitoring and evaluating the physical configuration of multiple distributed devices in a dynamic environment, and to detect deviations from an expected configuration in real time. The disclosure further describes a system and method for coordinating data from multiple sensing modalities and multiple devices to determine a system-level state, while also enabling responsive system behavior that adapts to detected changes in physical conditions.

In accordance with an aspect of an embodiment, there is provided a system for monitoring and controlling traffic control devices deployed in a work zone, the system comprising: a plurality of traffic control devices distributed within the work zone, the traffic control devices comprising: sensors configured to detect a physical condition of the respective traffic control device, including at least one of position, orientation, and motion; and a device communication module; a central control system comprising: a central communication module configured to communicate with the plurality of traffic control devices to receive telemetry therefrom, a template inference engine configured to identify a traffic control plan applicable to the work zone from spatial relationships among the traffic control devices, a compliance engine configured to: determine an expected physical configuration of the traffic control devices within the work zone from the identified plan, determine a deviation between the telemetry and the expected physical configuration of the traffic control devices, determine a compliance state of the traffic control devices based on the deviation, and when it is determined that the traffic control devices are compliant with the traffic control plan, communicate with the traffic control devices, causing the traffic control devices to modify their operation.

The compliance engine may access a repository of predefined traffic control plans and selects the traffic control plan based on correspondence between the spatial relationships of the traffic control devices and predefined configurations of the traffic control plan. The central control system may evaluate a plurality of candidate traffic control plans and selects the traffic control plan based on a composite score. The composite score may be based on weighted contributions of at least one of sign type correspondence, geometric correspondence, sequence correspondence, and spacing correspondence.

The compliance state may be determined based on comparison of at least one of position, orientation, or tilt of the traffic control devices in the work zone with the expected position, orientation, or tilt of the traffic control devices in the traffic control plan.

The control instruction may cause the traffic control device to transition between an active mode and a reduced-power monitoring mode.

The central control system may be configured to detect formation of the work zone based on clustering of the traffic control devices within a threshold distance. The clustering may be based on a configurable device cluster radius and a minimum number of traffic control devices.

The control instruction may cause the traffic control device to transition from an active telemetry mode to a reduced-power monitoring mode when compliant, and to return to the active telemetry mode in response to detected movement.

The compliance engine may be further configured to monitor a frequency of the communication from each of the plurality of traffic control devices and, when no communication has been received for more than a predefined messaging time from one of the plurality of traffic control devices, prompt a manual inspection of the traffic control device.

In accordance with another aspect of an embodiment, there is provided a sensing device for use with traffic control device, the sensing device comprising: a positioning sensor configured to determine a geographic position; a motion sensor configured to detect movement or tilt; a communication module; and a controller configured to: activate the sensing device in response to deployment of the traffic control device; acquire telemetry representing physical conditions of the traffic control device; transmit the telemetry to a central control system; and modify an operational mode of the sensing device based on a control instruction received from the central control system.

The sensing device may further comprise a deployment sensor configured to detect a transition of the traffic control device from a stowed configuration to a deployed configuration. The deployment sensor may comprise a switch configured to be actuated by a structural member of the traffic control device during deployment. The structural member may comprise a rib-member or cross-member of a collapsible frame of the traffic control device.

Actuation of the switch may cause the sensing device to transition from a standby mode to an active mode, wherein in the active mode the positioning sensor and the motion sensor are activated thereby consuming more power than in the standby mode. The controller may be configured to cause the sensing device to transition from the active mode to a monitor in response to the control instruction received from the central control system, wherein in the monitor mode the positioning sensor is deactivated to conserve power. Detection of movement by the motion sensor may cause the controller to transition from the monitor mode to the active mode.

The sensing device may further comprise an orientation sensor configured to determine an orientation or bearing of the traffic control device relative to a reference direction.

In accordance with yet another aspect of an embodiment, there is provided a method for monitoring and controlling traffic control devices deployed in a work zone, the method comprising: receiving, at a central control system, telemetry from the traffic control devices, the telemetry representing a physical condition of the traffic control device, including at least one of position, orientation, and motion; identifying a traffic control plan applicable to the work zone from spatial relationships among the traffic control devices, determining an expected physical configuration of the traffic control devices within the work zone from the identified plan, determining a deviation between the telemetry and the expected physical configuration of the traffic control devices, determining a compliance state of the traffic control devices based on the deviation, and when it is determined that the traffic control devices are compliant with the traffic control plan, causing the traffic control devices to modify their mode of operation.

In accordance with yet another aspect of an embodiment, there is provided a method for controlling a sensing device for use with a traffic control device , the method comprising: activating the sensing device in response to deployment of the traffic control device; acquiring telemetry representing physical conditions of the traffic control device; transmitting the telemetry to a central control system; and modifying an operational mode of the sensing device in response to a control instruction received from the central control system.

### BRIEF DESCRIPTION OF THE DRAWINGS

Embodiments will now be described by way of example only with reference to the following drawings in which:

FIG. 1 is a block diagram of a system for monitoring and controlling traffic control devices deployed in a work zone;

FIG. 2a is front view of an example traffic control device;

FIG. 2b is a rear view of the example traffic control device;

FIG. 3 is a block view of a sensing device;

FIG. 4 is a flow chart illustrating operation of the sensing device; and

FIG. 5 is a flow chart illustrating operation of the system.

### DETAILED DESCRIPTION OF THE PREFERRED EMBODIMENTS

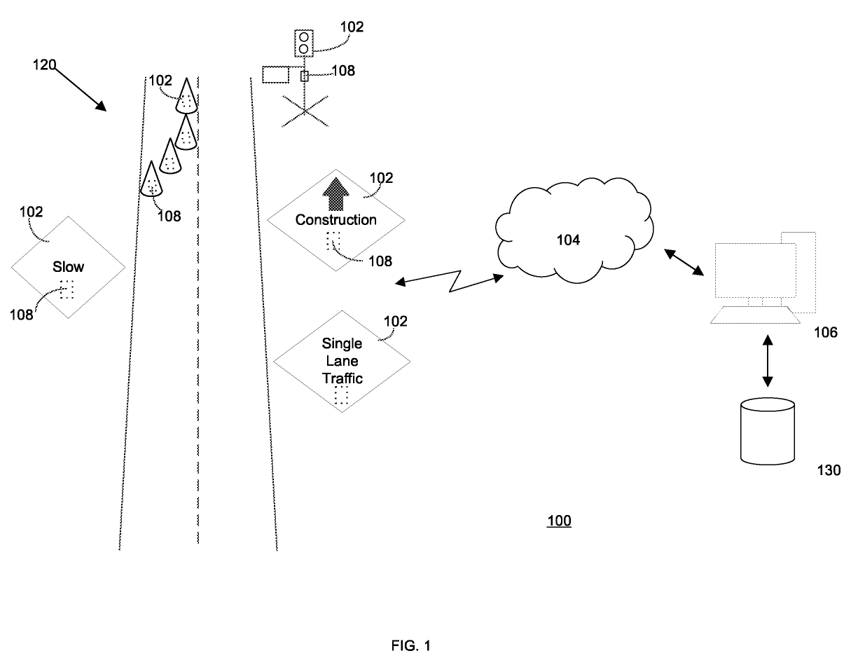

For convenience, like numerals in the description refer to like structures in the figures. Referring to FIG. 1, a system for monitoring and controlling traffic control devices deployed in a work zone is illustrated generally by numeral 100. The system 100 includes a plurality of traffic control devices 102, a communication network 104 and a central control system 106.

The traffic control devices 102 are distributed within a work zone 120. In some embodiments, the traffic control devices 102 include smart signs. In some embodiments, the traffic control devices 102 include smart cones. In some embodiments, the traffic control devices 102 include automated flagger assistance devices. In some embodiments the traffic control devices 102 include a combination of smart signs, smart cones, and/or automated flagger assistance devices. In some embodiments, the traffic control devices include arrow boards, message boards, barricades, vehicles and Truck Mounted Attenuators (TMAs). Each of the traffic control devices 102 includes a sensing device 108.

In some embodiments, the communication network 104 includes a mobile network. The mobile network includes wireless broadband technologies to facilitate communication over wireless wide area networks (WWANs) and/or wireless local area networks (WLANs). WWANs use mobile communication technologies like 3G, 4G LTE, 5G, 6G and the like to connect devices to a network, such as the Internet. WLANs use radio waves to connect the devices to the network. For example, this may be done using LoRa (Long Range), which is a low-power, spread-spectrum radio modulation technique designed for long-distance, low-data-rate communication. As another example, this may be done using the IEEE 802.11 Wi-Fi standards. As will be appreciated, various public and proprietary techniques may be used.

The central control system 106 is in communication with the traffic control devices 102 via the communication network 104. The central control system 106 may be implemented as a centralized server, a distributed cloud-based platform, or a combination of local and remote computing resources. As will be described, the central control system 106 is configured to receive, process, and respond to telemetry generated by the traffic control devices. Specifically, the central control system 106 is configured to ensure that the traffic control devices 102 are physically configured according to a corresponding traffic control plan.

As is known in the art, a traffic control plan defines the arrangement of the traffic control devices 102 within the work zone 120. The smart signs are used for notifying traffic of control measures in place at the work zone 120, and include warning such as “ROAD WORK AHEAD”, ONE LANE ROAD AHEAD, BE PREPARED TO STOP, and the like. A flagger may be provided for controlling single lane traffic flow in both directions around the work zone 120. The flagger may be human operated or automated.

The traffic control plan defines how the traffic control devices 102 must be deployed within the work zone 120 to comply with governmental codes/statutes. As will be described, the central control system 106 selects the traffic control plan from a plurality of traffic control plans stored in a repository 130. The repository 130 may be hosted by the central control system 106, by a remote system, or by a third party system.

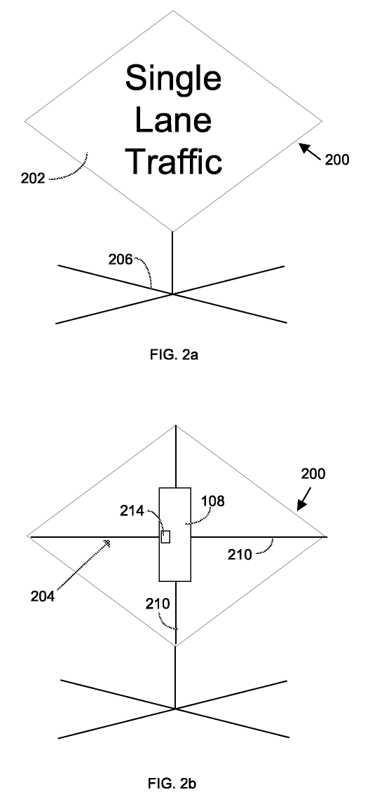

Referring to FIGS. 2a and 2b, an example of the traffic control device 102 is illustrated generally by numeral 200. In the illustrated example, the traffic control device 200 is the smart sign. In some embodiments, the smart sign 200 is a collapsible sign including flexible sign panel 202, frame structure 204, and a frame base 206.

The flexible sign panel 202 is supported by the frame structure 204. The frame structure 204 includes a plurality of interconnected cross- members 210 configured to transition between a stowed configuration and a deployed configuration. For example, in some embodiments, the cross-members 210 include one or more resilient or pivotable cross-ribs that expand outward to tension the sign panel when deployed and collapse inward when the sign is folded for transport or storage. In some embodiments, the frame base 206 is configured to position the sign panel 202 in an upright orientation adjacent a roadway during use.

In some embodiments, the sensing device 108 is coupled to the frame structure 204. In some embodiments, the sensing device 108 includes a housing that is coupled to an element of the frame structure 204 that undergoes movement during deployment, such as the rib-member 210. In some embodiments, the housing is a weather-resistant enclosure. The sensing device 108 is coupled to the frame structure 204 so that it does not interfere with normal operation of the sign. The sensing device 108 is oriented such that sensors within the sensing device 108 can accurately detect physical conditions of the sign, including position, orientation, and motion.

In some embodiments, the sensing device 108 is configured to detect a transition of the collapsible sign from the stowed configuration to the deployed configuration. For example, a structural element of the frame structure 204, such as the cross-rib 210, may be configured to contact or actuate a switch 214 when the smart sign 200 is expanded. As will be described, this interaction may be used to automatically activate the sensing device 108. Because the sensing device 108 is activated by movement of the frame structure 204 during normal deployment, the sensing device 108 operates without requiring manual input from a user and remains transparent to standard setup procedures.

In some embodiments, the switch 214 is a mechanical switch such as a lever, button, or plunger, for example. As the cross-rib 210 moves into its deployed position, it may contact and displace an actuator element of the switch, thereby activating the sensing device 108. In some embodiments, the switch 214 is positioned such that actuation occurs only when the sign is substantially fully deployed. This reduces false activations of the sensing device 108 during intermediate movement of the frame structure. The interaction between the cross-rib 210 and the switch 214 may be configured to tolerate variations in alignment, vibration, and environmental conditions, for example by providing a compliant actuator surface or a range of actuation travel.

In some embodiments, the switch 214 may comprise a non-contact sensor, such as a magnetic, optical, or proximity sensor configured to detect movement or a position of the cross-rib or other structural element of the frame structure 204.

In some embodiments, the sensing device 108 is powered by an internal power source, such as a rechargeable battery, configured to provide electrical energy for operation of the sensing device 108 without requiring external connections.

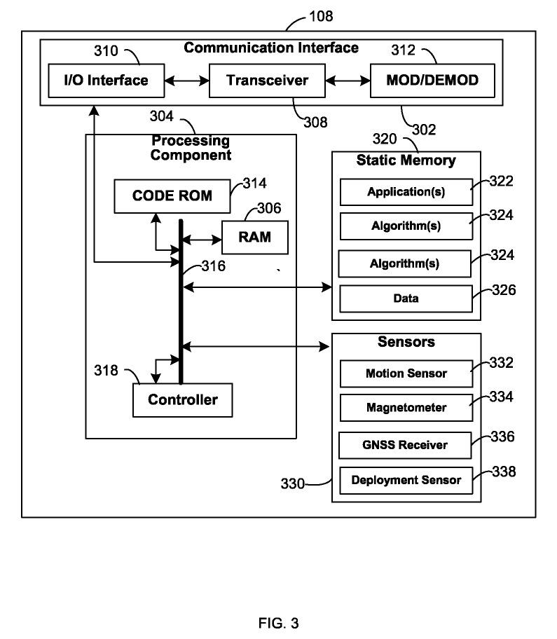

Referring to FIG. 3, a schematic block diagram of an example of the sensing device 108 is illustrated generally. The sensing device 108 may include a communication interface 302, a processing component 304, a memory 320, and sensors 330.

The communication interface 302 includes one or more transceivers 308, input/output (I/O) interfaces 310, and modems 312. The I/O interfaces 310 may include one or more wired and/or wireless interfaces that are configurable to communicate with suitable components of the sensing device 108. For example, the I/O interfaces 310 may interface with a touchscreen, keypad, camera, and/or display.

The one or more transceivers 308 may be adapted for communication with the communication network 104 for communicating with the central control system 106. For example, the one or more transceivers 308 may be adapted for communication with one or more of the WWANs and/or the WLANs. Thus, the one or more transceivers 308 may include a cell phone transceiver, a 3GPP transceiver, an LTE transceiver, a GSM transceiver, a 5G/6G transceiver, a Bluetooth transceiver, a Wi-Fi transceiver, and/or another similar type of wireless transceiver configurable to communicate via the communication network 104.

The communication interface 302 may further include one or more wireline transceivers 308, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 308 may also be coupled to the modem 312.

The processing component 304 may include a Read Only Memory (ROM) 314, a Random Access Memory (RAM) 306, a common data and address bus 316 and a controller 318. The ROM 314, the RAM 306, and the controller 318 are communicatively coupled to the common data and address bus 316. Further, the communication interface 302, the memory 320, and the sensors 330 are communicatively coupled to the processing component 304 via the common data and address bus 316.

The controller 318 may include one or more logic circuits, one or more processors, one or more microprocessors, one or more GPUs (Graphics Processing Units), and/or the controller 318 may include one or more ASIC (application-specific integrated circuits) and one or more FPGA (field-programmable gate arrays), and/or another electronic device.

The memory 320 provides a non-transitory computer readable medium for storing machine readable instructions to implement one or more programs 322 or applications 324, program code, and/or application data 326.

Thus, for example, the memory 320 may comprise a non-transitory computer-readable storage medium having stored thereon program instructions that, when executed by the controller 318, cause the controller 318 to perform a set of operations as will be described herein. The application 322 and/or one or more of the algorithms 324 may include programmatic algorithms, and the like, to implement functionality as described herein.

In some embodiments, the sensors 330 include one or more of a motion sensor 332, an orientation sensor 334, a positioning sensor 336, and a deployment sensor 338.

In some embodiments, the controller 318 is configured to control operation of the sensing device 108, and to execute instructions for acquiring, processing, and transmitting data from the sensors 330. The controller 318 may operate in multiple power states to balance performance and energy consumption. The controller 318 coordinates operation of the sensors 330. The controller 318 also processes signals from the sensors to generate telemetry representing physical conditions of the traffic control device 104. The controller further manages communication with the central control system 106. In some embodiments, the controller 318 implements local decision logic for determining whether to activate or suppress sensing or communication functions based on detected physical conditions.

The motion sensor 332 is configured to detect movement and orientation of the associated traffic control device. In some embodiments, the motion sensor 332 is an accelerometer. The motion sensor 332 may produce signals indicative of linear acceleration along multiple axes, which may be used to determine tilt relative to normal and to detect motion events such as displacement, impact, or repositioning. In some embodiments, the motion sensor 332 operates continuously in a low-power monitoring mode to detect changes in device state. In some embodiments, the motion sensor 332 may be used to trigger activation of additional sensing or communication functions in response to detected movement or deviation from an expected orientation.

In some embodiments, the orientation sensor 334 is a magnetometer configured to measure a magnetic field. In some embodiments, the magnetic field is used to determine directional data, such as an orientation or bearing of the traffic control device 102 relative to a reference direction. The directional data facilitates determination of whether the traffic control device 102 is oriented in accordance with an expected configuration, such as facing oncoming traffic.

The positioning sensor 336 is configured to determine a geographic position of the traffic control device 102. In some embodiments, the positioning sensor is a Global Navigation Satellite System (GNSS) receiver configured to support one or more global navigation satellite systems and provides position data sufficiently accurate to evaluate spatial relationships among multiple traffic control devices 102 within the work zone 120. Examples of global navigation satellite systems include Global Positioning System (GPS), Global Navigation Satellite System (GLONASS), Galileo, and BeiDou. The position determined by the receiver is used to establish relative spacing and placement of traffic control devices and to enable a comparison of the actual position of the traffic control device 102 to its expected position.

The deployment sensor 338 is configured to detect whether the traffic control device 102 has been deployed. In some embodiments, the deployment sensor 338 comprises a switch positioned to be actuated by a structural element of the traffic control device 102, such as a frame component, when the traffic control device 102 is deployed. Actuation of the deployment sensor 338 may trigger activation of the sensors 330. In this manner, activation of the sensors 330 is coupled to the physical deployment of the traffic control device 102 without requiring user interaction.

In some embodiments, the sensing device 108 operates according to a state machine. In some embodiments, there are four primary states: Standby, Sleep, Active, and Monitor. Sleep is a sub-state of Standby. Monitor is a sub-state of Active.

In the Sleep state, the sensing device 108 is in a deep low-power mode. In this state, the sensing device 108 is configured to be woken by a real time clock (RTC) alarm. This enables the sensing device 108 to wake up at scheduled intervals to perform actions such as sending a heartbeat message or checking for events. In some embodiments, the heartbeat messages are communicated using the Constrained Application Protocol (CoAP). The heartbeat message confirms the liveness of the sensing device 108 to the central control system 106. The heartbeat message further provides a channel for the central control system 106 to queue commands for the sensing device 108. Examples of commands include, for example, state transitions, configuration changes, over-the-air (OTA) update triggers, and the like. In some embodiments, a heartbeat response from the central control system 106 to the sensing device 108 indicates whether queued commands exist but does not include the commands themselves. Thus, the sensing device 108 can remain in low-power mode when no commands are pending or wake up when commands are pending.

This state allows the sensing device 108 to maintain periodic operation and synchronization without keeping higher-power components continuously active, thereby supporting energy-efficient operation. This provides minimal power consumption for storage and transit.

In the Standby state, the sensing device 108 the modem 312 and the GNSS receiver 336 are active. The remaining sensors 330 are inactive. In some embodiments, the Standby state is used primarily when the traffic control device 102 is being taken down. In some embodiments, the sensing device 108 uses the MQTT protocol for communicating with the central control system 106.

In the Active state, the sensing device 108 is fully operational. All sensors 330 are actively measuring telemetry data. In some embodiments, the telemetry includes position, bearing, tilt, and battery. The telemetry measured by the sensors 330 is continually communicated using MQTT. In some embodiments, the telemetry is communicated at predefined intervals. For example, a default interval may be 60 seconds.

In the Monitor state, the modem 312 and the GNSS receiver 336 are inactive and the motion sensor 332 is active. As will be described, the motion sensor 332 is active to facilitate wake-up of the sensing device 108 in response to detected movement. In this state, the sensing device 108 is configured to send the heartbeat message or check for events.

In some embodiments, an OTA state is provided to facilitate firmware downloads to the sensing device 108. The modem 312 is active to receive the firmware download, which is downloaded and installed at the sensing device 108. All sensors 330 remain off in the OTA state.

Accordingly, it will be appreciated that the sensing device 108 may operate in a reduced-power monitoring state in which one or more higher-power components are disabled while selected sensors remain active to detect changes in physical conditions. For example, the motion sensor 332 may remain active to detect movement of the traffic control device 102, while the other sensors are temporarily inactive. In response to detecting a change in physical condition using the motion sensor, the sensing device 108 may transition from a reduced-power state back to a more power-intensive state to resume sensing and communication operation.

In some embodiments, the transitions between states may be controlled by instructions received from the central control system 106. For example, when the central control system 106 determines that the traffic control device 102 is in a compliant configuration, the computing system may transmit a control instruction causing the sensing device to transition from a power-intensive state to a reduced-power state. In this manner, operation of the sensing device 108 is governed by a closed-loop interaction between sensed physical conditions and externally generated control instructions, enabling adaptive management of sensing and communication behavior based on the state of the system.

In operation, each sensing device 108 is configured to automatically activate and manage sensing and communication functions based on physical deployment of the associated traffic control device 102 and subsequent control instructions received from the central control system 106. Activation of the sensing device 108 is initiated in response to deployment of the traffic control device 102, such as actuation of the deployment sensor 338 caused by movement of the cross-member 210 of the traffic control device 102 during setup.

Upon activation, the sensing device 108 transitions from the Sleep or Standby, low-power, state to the Active state. In the Active state, all the sensors 330 are enabled to acquire telemetry representing physical conditions of the traffic control device 102. In the Active state, the sensing device 108 determines at least one of position, orientation, motion, or connectivity, and transmits the telemetry to the central control system 106 via the communication interface 302.

In some embodiments, the sensing device 108 continues to operate in the active state during an initial evaluation period, during which telemetry is periodically transmitted to the central control system 106. The sensing device 108 may maintain this Active state until a control instruction is received from the central control system 106 indicating that the traffic control device 102 is in a compliant configuration.

In response to receiving the control instruction, the sensing device 108 transitions from the Active state to the Monitor state, which is a reduced-power monitoring state. In the Monitor state, the higher-power components, such as the GNSS receiver 336 and the modem 312, may be disabled. The motion sensor 332 remains active to detect changes in physical conditions of the traffic control device 102. In some embodiments, the sensing device 108 periodically transmits a heartbeat message to maintain communication with the central control system 106.

While in the Monitor state, the sensing device 108 monitors for a triggering event indicative of a change in physical condition of the traffic control device 102. In some embodiments, the triggering event includes detection of movement or displacement, by the motion sensor 332. In some embodiments, the movement or displacement must be greater than a predefined threshold before the triggering event is considered to occur. In response to detecting the triggering event, the sensing device 108 transitions from the Monitor state to the Active state to ensure that the traffic control device 102 remains compliant with the traffic control plan.

In some embodiments, the sensing device 108 may also transition from the Monitor state to the Active state in response to receiving a control instruction from the central control system 106. Upon returning to the Active state, the sensing device 108 resumes acquisition and transmission of telemetry for evaluation by the central control system 106.

Accordingly, the operational lifecycle of the traffic control device 102 includes activation of the sensing device 108 in response to physical deployment of the traffic control device, transmission of telemetry representing physical conditions during an evaluation phase, determination of a compliance state based on deviation from an expected physical configuration, and transmission of a control instruction causing the sensing device to modify an operational mode. In response to the compliance state, the sensing device 108 may transition to a reduced-power monitoring mode and subsequently return to the Active mode upon detection of movement or disturbance. This lifecycle implements a closed-loop control process that reduces power consumption while maintaining the ability to detect changes in physical conditions and to update the compliance state based on newly received telemetry.

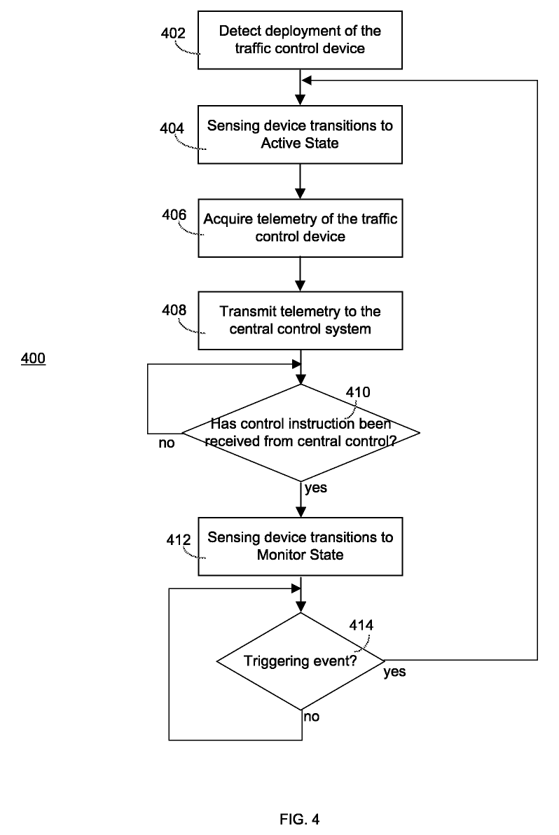

Referring to FIG. 4, a flow diagram illustrating operation of the sensing device 108 is shown generally by numeral 400. At block 402, deployment of the traffic control device 102 is detected, such as by actuation of the deployment sensor 338.

At block 404, the sensing device 108 transitions to the Active state. At block 406, the sensing device 108 acquires telemetry representing physical conditions of the traffic control device 102, including at least one of position, orientation, motion, or connectivity. At block 408, the sensing device 108 transmits the telemetry to the central control system 106.

At block 410, the sensing device 108 determines whether a control instruction indicating that the traffic control device 102 is compliant with the traffic control plan has been received from the central control system 106. Upon receipt of the control instruction indicating that the traffic control device 102 is in a compliant configuration, at block 412, the sensing device 108 transitions to the Monitor state.

The sensing device 108 continues to operate in the Monitor state, including maintaining a motion sensor active to detect changes in physical condition. When a change in the physical condition of the traffic control device meets the threshold for the triggering event then, at block 414, the sensing device 108 transitions from the Monitor state to the Active state 404.

In operation, the system 100 autonomously monitors and controls deployment of the traffic control devices 102 within the work zone 120 based on telemetry received from the sensing devices 108. The central control system 106 receives telemetry representing physical conditions of the traffic control devices 102, including position, orientation, motion, and connectivity. The central control system 106 processes the telemetry to determine spatial relationships among the traffic control devices 102 and to identify a grouping of devices corresponding to the work zone 120.

In some embodiments, the central control system 106 detects formation of the work zone 120 based on spatial clustering of the traffic control devices 102. For example, when two or more traffic control devices 102 are within a threshold proximity, the central control system 106 designates the devices as belonging to the same work zone 120. This detection may occur without user input and may be based solely on the received telemetry.

The central control system 106 determines a traffic control plan applicable to the work zone 120 based on spatial relationships and characteristics of the traffic control devices 102. The traffic control plan may be determined based on device type, relative position, sequence, and/or roadway attributes.

In some embodiments, determination of the traffic control plan applicable to the work zone 120 is performed by evaluating correspondence between observed characteristics of the traffic control devices 102 and a plurality of candidate traffic control plans stored in a repository. The evaluation may be based on a weighted scoring process in which multiple factors associated with the observed physical deployment of the traffic control devices 102 are compared to corresponding characteristics defined by each candidate traffic control plan.

For example, in some embodiments, the evaluation includes a sign type correspondence factor, representing a degree to which types of traffic control devices 102 present in the work zone match device types specified by a candidate traffic control plan.

In some embodiments, the evaluation further includes a geometric correspondence factor, representing a degree of similarity between a spatial arrangement of the traffic control devices 102 and an expected geometric arrangement defined by the candidate traffic control plan, such as alignment along an approach path or distribution across defined zones of the work zone.

In some embodiments, the evaluation further includes a sequence correspondence factor, representing whether the traffic control devices 102 are arranged in an order consistent with a sequence specified by the candidate traffic control plan.

In some embodiments, a spacing correspondence factor is evaluated, representing a degree of deviation between measured distances among the traffic control devices 102 and spacing values defined by the candidate traffic control plan.

In some embodiments, each factor is associated with a weighting that reflects relative importance of that factor in determining correspondence between the observed physical configuration of the traffic control devices 102 and the candidate traffic control plan. For example, correspondence of device types may be assigned a higher weighting than spacing correspondence, while geometric arrangement and sequence may be assigned intermediate weightings. A composite score may be calculated for each candidate traffic control plan based on the weighted combination of the evaluated factors.

The central control system 106 selects the traffic control plan having a highest composite score as the traffic control plan applicable to the work zone 120. Other thresholds may also be defined. For example, traffic control plans with a composite score less than a predefined matching threshold are considered pending matches. Traffic control plans with a composite score greater than the predefined matching threshold are considered inferred matches. In some embodiments, a user may manually select or confirm one of the inferred traffic control plans as the selected traffic control plan.

In some embodiments, the determination of the traffic control plan is refined as additional traffic control devices 102 are deployed and additional telemetry is received. As a result, the correspondence between the observed configuration and the candidate traffic control plans may change over time, and the selected traffic control plan may be updated when a higher correspondence is identified. In some embodiments, a minimal improvement threshold is applied before selecting a new candidate traffic control plan. This action inhibits oscillating between candidate traffic control plans with minimal differences, thereby providing stability in the determination.

In some embodiments, a device cluster radius defines a maximum allowable distance between the traffic control devices 102 for inclusion in a common work zone 120. For example, traffic control devices 102 located within a threshold distance of one another may be grouped together as part of the same work zone. A minimum device threshold may further be applied, such that the work zone 120 is identified only when at least a specified number of traffic control devices 102 are detected within the device cluster radius. This inhibits isolated or transient devices from incorrectly being identified as a work zone.

In some embodiments, a proximity threshold is a distance threshold used to inhibit creation of duplicate work zones 120 in close geographic proximity of each other. For example, when a newly detected cluster of traffic control devices 102 is within the proximity threshold of the work zone 120, the central control system 106 may associate the devices with the work zone 120 rather than creating a new work zone.

Additionally, in some embodiments, a significant movement threshold may be used to determine when movement of the traffic control device 102 is sufficient to trigger re-evaluation of the work zone configuration or reassignment of the device. That is, if the traffic control device 102 moves further than the significant movement threshold, the work zone configuration is re-evaluated.

In some embodiments, a detachment radius is defined to determine when a traffic control device 102 should no longer be associated with a work zone 120. For example, when a traffic control device 102 moves beyond a threshold distance from the work zone, the central control system 106 may automatically remove the device from the work zone. This allows the system 100 to dynamically adapt to changes in device placement as traffic control devices 102 are repositioned or removed.

In some embodiments, a reactivation window is defined to manage temporal continuity of the work zone 120. When traffic control devices 102 are removed and later redeployed within a defined time period and geographic proximity, the central control system 106 may associate the devices with a previously created work zone rather than creating a new work zone. This allows the system 100 to maintain continuity of monitoring and historical data for work zones that are temporarily disassembled and re-established. For example, some works zones 120 may be torn down and rebuilt at the end of a day or over a weekend, for example.

Based on the selected traffic control plan, the central control system 106 computes an expected physical configuration for each of the traffic control devices 102 within the work zone 120. The expected physical configuration represents a modeled arrangement of the traffic control devices 102 corresponding to the selected traffic control plan and defines expected physical parameters for each device within the work zone 120.

The expected physical configuration may be computed accounting for: template-defined minimum spacing between devices; an approach direction (determined from the bearing between traffic control devices 102); a template zone structure includes advance warning, transition, buffer, activity, and termination areas; and road geometry including straight segments, curves, intersections, and the like.

In some embodiments, the expected physical configuration is stored along with their derivation. For example, Template Direct indicates that the position was calculated purely from template geometry rules. Anchor Derived indicates that the position was calculated relative to an anchor device location. In some embodiments, the anchor device is the first deployed traffic control device 102. Template Modified indicates that the position was adjusted by an operator through a user interface. Manually Placed indicates that the position was set entirely by the operator without template reference.

The central control system 106 determines a deviation between the telemetry and the expected physical configuration and determines a compliance state of each traffic control device 102 based on the deviation. The compliance state may be further aggregated to determine a compliance state for the work zone 120.

In some embodiments, the central control system 106 evaluates the compliance state by comparing measured physical conditions, as represented by telemetry, to the expected physical configuration. This evaluation may be performed using a multi-factor scoring process in which deviations between measured and expected values are quantified and combined to determine a compliance state.

For each traffic control device 102, the central control system 106 may determine one or more deviation values, including a position deviation, an orientation deviation, and a tilt or motion deviation. The position deviation represents a difference between a measured position and an expected position. The orientation deviation represents a difference between a measured bearing and an expected bearing. The tilt or motion deviation represents a difference between a measured physical angle or motion and the expected physical angle or motion.

In some embodiments, the compliance evaluation is represented by a scoring model in which multiple deviation factors are weighted and combined to determine an overall compliance score for each traffic control device 102. Each deviation factor includes an acceptable range from the ideal. The scoring model may include, for example, a position component, a bearing component, and a tilt component. The position component reflects how closely the measured position matches the expected position. The orientation component reflects alignment of the direction of the traffic control device 102 relative to an expected direction. The stability component reflects whether the traffic control device is upright and stationary.

The traffic control device 102 is considered compliant only when all deviation factors are within compliant thresholds. Warnings may be issued when the deviation factors approach their limits. The warnings are informational and do not affect overall compliance status. A site is considered compliant when all assigned devices are individually compliant, or when non-compliant devices are explicitly acknowledged by the site operator.

Based on the compliance state, the central control system 106 transmits control instructions to one or more of the traffic control devices 102, causing the sensing devices 108 to modify operation. For example, when the central control system 106 determines that the traffic control device 102 is compliant it sends a command to the sensing device 108. In turn, the sensing device 108 transitions to a reduced-power monitoring mode. The sensing device 108 may transition to an active mode in response to detected movement in response to motion detected by the motion sensor 332 or instruction from the central control system 106. Accordingly, the system 100 operates as a closed-loop control system in which sensed physical conditions are used to dynamically control operation of the sensing devices 108.

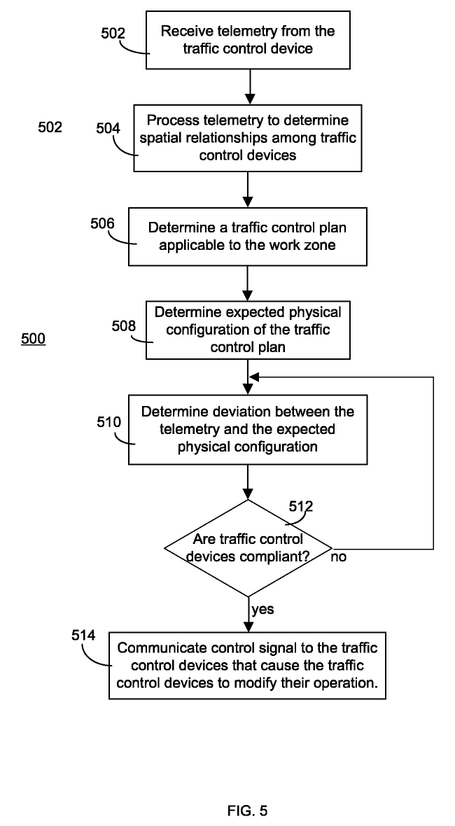

Referring to FIG. 5, a flow diagram illustrating operation of the central control system 106 is shown generally by numeral 500. At block 502, telemetry is received from the traffic control devices 102 deployed within the work zone 120. The telemetry represents physical conditions of the traffic control devices 102, including at least one of position, orientation, motion, or connectivity.

At block 504, a template inference engine at the central control system 106 processes the telemetry to determine spatial relationships among the traffic control devices 102 and to identify a grouping of devices corresponding to a work zone.

At block 506, the template inference engine determines a traffic control plan applicable to the work zone based on the spatial relationships and characteristics of the traffic control devices 102.

At block 508, a compliance engine at the central control system 106 determines an expected physical configuration of the traffic control devices 102 within the work zone based on the traffic control plan.

At block 510, the compliance engine determines a deviation between the telemetry and the expected physical configuration.

At block 512, the compliance engine determines a compliance state of at least one traffic control device 102 based on the deviation. When it is determined that the traffic control devices 102 are compliant with the traffic control plan, at block 514 a control signal is communicated to the traffic control devices 102, causing the traffic control devices 102 to modify their operation.

The central control system 106 continues to receive updated telemetry and repeats the evaluation process, thereby enabling continuous monitoring and control of the traffic control devices 102 within the work zone 120.

In some embodiments, the central control system 106 is further configured to monitor a frequency of communications from each of the plurality of traffic control devices 102. That is, the central control system 106 determines a time between each of the messages received from the traffic control devices, either by CoAP or MTTQ protocols. When it is determined that a communication has not been received from one of the traffic control devices 102 for more than a predefined messaging time, the traffic control device 102 is considered offline. In response, the central control system 106 communicates a message to the work zone 120 to prompt a manual inspection of the traffic control device 102.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the "C" programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through the LAN or the WAN, or the connection may be made to an external computer (for example, through the Internet using an Internet Service Provider).

The term “one of”, without a more limiting modifier such as “only one of”, and when applied herein to three or more subsequently defined options such as “one of A, B, and C” should be construed to mean an existence of any one of the options in the list alone (e.g., A alone, B alone, or C alone) or any combination of the three or more of the options in the list (e.g., A and B and C together, A and B together, A and C together, or B and C together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

What is claimed is:

1. A system for monitoring and controlling traffic control devices deployed in a work zone, the system comprising:
a plurality of traffic control devices distributed within the work zone, the traffic control devices comprising:
sensors configured to detect a physical condition of the respective traffic control device, including at least one of position, orientation, and motion; and
a device communication module;
a central control system comprising:
a central communication module configured to communicate with the plurality of traffic control devices to receive telemetry therefrom,
a template inference engine configured to identify a traffic control plan applicable the work zone from spatial relationships among the traffic control devices,
a compliance engine configured to:
determine an expected physical configuration of the traffic control devices within the work zone from the identified plan,
determine a deviation between the telemetry and the expected physical configuration of the traffic control devices,
determine a compliance state of the traffic control devices based on the deviation, and
when it is determined that the traffic control devices are compliant with the traffic control plan, cause the traffic control devices to modify their mode of operation.

2. The system of claim 1, wherein the compliance engine accesses a repository of predefined traffic control plans and selects the traffic control plan based on correspondence between the spatial relationships of the traffic control devices and predefined configurations of the traffic control plan.

3. The system of claim 2, wherein the central control system evaluates a plurality of candidate traffic control plans and selects the traffic control plan based on a composite score.

4. The system of claim 3, wherein the composite score is based on weighted contributions of at least one of sign type correspondence, geometric correspondence, sequence correspondence, and spacing correspondence.

5. The system of claim 2, wherein the compliance state is determined based on comparison of at least one of position, orientation, or tilt of the traffic control devices in the work zone with the expected position, orientation, or tilt of the traffic control devices in the traffic control plan.

6. The system of claim 1, wherein the control instruction causes the traffic control device to transition between an active mode and a reduced-power monitoring mode.

7. The system of claim 1, wherein the central control system is configured to detect formation of the work zone based on clustering of the traffic control devices within a threshold distance.

8. The system of claim 7, wherein the clustering is based on a configurable device cluster radius and a minimum number of traffic control devices.

9. The system of claim 1, wherein the control instruction causes the traffic control device to transition from an active telemetry mode to a reduced-power monitoring mode when compliant, and to return to the active telemetry mode in response to detected movement.

10. The system of claim 1, wherein the compliance engine is further configured to monitor a frequency of the communication from each of the plurality of traffic control devices and, when no communication has been received for more than a predefined messaging time from one of the plurality of traffic control devices, prompt a manual inspection of the traffic control device.

11. A sensing device for use with a traffic control device, the sensing device comprising:
a positioning sensor configured to determine a geographic position;
a motion sensor configured to detect movement or tilt;
a communication module; and
a controller configured to:
activate the sensing device in response to deployment of the traffic control device;
acquire telemetry representing physical conditions of the traffic control device;
transmit the telemetry to a central control system; and
modify an operational mode of the sensing device in response to a control instruction received from the central control system.

12. The sensing device of claim 11, further comprising a deployment sensor configured to detect a transition of the traffic control device from a stowed configuration to a deployed configuration.

13. The sensing device of claim 12, wherein the deployment sensor comprises a switch configured to be actuated by a structural member of the traffic control device during deployment.

14. The sensing device of claim 13, wherein the structural member comprises a rib-member or cross-member of a collapsible frame of the traffic control device.

15. The sensing device of claim 13, wherein actuation of the switch causes the sensing device to transition from a standby mode to an active mode, wherein in the active mode the positioning sensor and the motion sensor are activated thereby consuming more power than in the standby mode.

16. The sensing device of claim 15 wherein the controller is configured to cause the sensing device to transition from the active mode to a monitor in response to the control instruction received from the central control system, wherein in the monitor mode the positioning sensor is deactivated to conserve power.

17. The sensing device of claim 16, wherein detection of movement by the motion sensor causes the controller to transition from the monitor mode to the active mode.

18. The sensing device of claim 11 further comprising an orientation sensor configured to determine an orientation or bearing of the traffic control device relative to a reference direction.

19. A method for monitoring and controlling traffic control devices deployed in a work zone, the method comprising:
receiving, at a central control system, telemetry from the traffic control devices, the telemetry representing a physical condition of the traffic control device, including at least one of position, orientation, and motion;
identifying a traffic control plan applicable to the work zone from spatial relationships among the traffic control devices,
determining an expected physical configuration of the traffic control devices within the work zone from the identified plan,
determining a deviation between the telemetry and the expected physical configuration of the traffic control devices,
determining a compliance state of the traffic control devices based on the deviation, and
when it is determined that the traffic control devices are compliant with the traffic control plan, causing the traffic control devices to modify their mode of operation.

20. A method for controlling a sensing device for use with a traffic control device, the method comprising:
activating the sensing device in response to deployment of the traffic control device;
acquiring telemetry representing physical conditions of the traffic control device;
transmitting the telemetry to a central control system; and
modifying an operational mode of the sensing device in response to a control instruction received from the central control system.
